(19) United States
(12) Patent Application Publication
(10) Pub. No.: US 2021/0027385 A1
(43) Pub. Date: Jan. 28, 2021

(54) SYSTEM AND METHOD OF ADJUSTING INSURANCE PREMIUMS

(71) Applicant: CTS Information Services, LLC d/b/a InsurePay, Fort Lauderdale, FL (US)

(72) Inventors: Randy Thomas Stich, Sarasota, FL (US); Gex Franklin Richardson, Fort Lauderdale, FL (US)

(73) Assignee: CTS Information Services, LLC d/b/a InsurePay, Fort Lauderdale, FL (US)

(21) Appl. No.: 16/519,193

(22) Filed: Jul. 23, 2019

(51) Int. Cl. G06Q 40/08; G06Q 20/20; G06N 20/00

(52) U.S. Cl. CPC G06Q 40/08; G06N 20/00; G06Q 20/20

(57) ABSTRACT

A system and method of adjusting insurance premiums during the term of an insurance policy are disclosed. In accordance with the disclosed subject matter, a dynamically adjusted insurance premium may vary based upon periodic data received from an insured, such that an insurance carrier may determine an accurate premium payment without having to wait for an audit.

### FIELD OF THE DISCLOSURE

The present disclosure relates generally to dynamic adjustment of insurance premiums during the term of an insurance policy, and in particular to a system and method of adjusting insurance premiums based upon periodic data received from an insured.

### BACKGROUND

Typically, insurance providers (each, a “carrier”) issuing general liability policies for restaurants, bars, gasoline stations, convenience stores, and other retail or commercial establishments (each, an “insured”) use an insured's previous year's sales or other historical financial data to estimate necessary general liability insurance coverage and, more importantly, attendant premium payments that are due to secure such coverage. In many retail and other industries, however, it is common for a given insured's sales receipts, revenue, or other historical data that are used for the insurance carrier's estimate to vary significantly from year to year (i.e., enough such that a year-over-year variation may affect the carrier's estimate, resulting in over- or under-payment on the part of the insured). This uncertainty may be exacerbated in the case of a start-up company, for instance, or if an insured is a relatively newly-formed entity, as such companies with short histories may have no way of predicting, a priori, sales or revenue figures for a given period based upon historical data. In these and other circumstances where historical data may be sparse or unreliable, an insurance carrier may not have sufficient data to make an accurate determination of what the actual premium should have been until incorrect premiums have been paid throughout the policy term (i.e., after a year has elapsed or the policy has expired and the insurance carrier has conducted an audit).

In practice, the audit and certification process may not conclude until weeks or months following expiration of the policy, at which point, the insured may have already extended or renewed the policy at an incorrect coverage level or premium rate (or both) based upon inaccurate historical data; in many instances, such incorrect coverage levels or premium rates are complicated to change during the policy term. Since coverage amounts and premium payments are traditionally based upon estimations, the insured may pay more or less than what would be appropriate if the policy were based upon better information, and both the insured and the insurance carrier must wait until the next year's audit to “true up” the policy by agreeing that additional payments are to be charged, on the one hand, or that overpayments are to be refunded or credited, on the other hand.

From at least the foregoing, it will be appreciated that what is needed is a system and method of adjusting insurance premiums during the term of an insurance policy, for instance, based upon periodic data received from an insured during the term, such that an insurance carrier may determine an accurate premium payment without having to wait for an audit. Such a system and method may have particular utility in connection with general liability insurance policies for insureds in the retail space, but the utility of the disclosed subject matter is not limited to such circumstances.

### BRIEF SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the disclosed subject matter in a simplified form as a prelude to the more detailed description that is presented later.

The present disclosure describes a system and method generally employing a “pay-as-you-go” paradigm. In that regard, actual sales or other relevant financial data may be collected, for example, from a point of sale (“POS”) terminal or other data processing system at the insured's location; additionally or alternatively, other types of data may be collected, for instance, from an invoicing system, an electronic commerce platform, or other data processing system that is operated or maintained by the insured (i.e., even if such a system were not on-site at the insured's location or deployed in a retail establishment). In any event, such sales data or other data or information that may be relevant to an insurance policy may be collected or aggregated in real time or near real time, either at the POS or the insured's location, or in connection with a remote system owned, operated, or maintained by the insured or in connection with the insured's business operations. Using data periodically collected from such sources, an accurate premium may be computed and dynamically adjusted throughout the policy year, which may eliminate or reduce the need for audits, or at least result in fewer audits determining that previous payments have been materially inaccurate.

In accordance with one aspect of the disclosed subject matter, for example, an insurance premium computation method may generally be summarized as comprising: periodically acquiring insured data from a data processing system operated or maintained by an insured, the insured data related to a business operated by the insured; applying rules logic to the insured data in combination with carrier data acquired from an insurance carrier and related to an insurance policy associated with the insured; computing a dynamically adjusted premium in accordance with output from the rules logic; obtaining a payment in an amount of the dynamically adjusted premium from a first account associated with the insured; and remitting the payment to a second account associated with the carrier.

Methods are disclosed wherein the data processing system is a financial resource system, wherein the financial resource system is a point of sale (“POS”) terminal, and/or wherein the financial resource system is an accounting software application. In some implementations, the computing comprises utilizing a machine learning algorithm. Additionally or alternatively, the periodically acquiring comprises receiving insured data related to a present financial transaction in near real time. In some methods, the insured data are representative of a monetary value of the present financial transaction.

In accordance with another aspect of the disclosed subject matter, an insurance premium computation system may generally comprise: a data processing system operated or maintained by an insured and operative to acquire insured data related to a business of the insured; rules logic to receive the insured data from the data processing system and carrier data from an insurance carrier, the carrier data related to an insurance policy associated with the insured; a processing component to compute a dynamically adjusted premium for the insurance policy in accordance with output from the rules logic; and a financial transaction engine, the financial transaction engine to obtain a payment in an amount of the dynamically adjusted premium from a first account associated with the insured and to remit the payment to a second account associated with the insurance carrier.

Systems are disclosed wherein the data processing system is a financial resource system, wherein the financial resource system is a point of sale (“POS”) terminal, and/or wherein the financial resource system is an accounting software application. In some implementations, the processing component utilizes a machine learning algorithm. In some disclosed implementations, the data processing system acquires insured data related to a present financial transaction in near real time. As set forth in more detail below, the insured data may be representative of a monetary value of the present financial transaction.

The foregoing and other aspects of various disclosed embodiments will be apparent through examination of the following detailed description thereof in conjunction with the accompanying drawing figures, in which like reference numerals are used to represent like components throughout, unless otherwise noted.

### BRIEF DESCRIPTION OF THE DRAWING FIGURES

FIG. 1 is a functional block diagram illustrating components of one implementation of a data processing and analytics system for use in connection with an insurance premium adjustment method.

FIG. 2 is a functional block diagram illustrating components of a logic engine supporting functionality of an insurance premium adjustment method.

FIG. 3 is a diagram illustrating a typical form insurance coverage quotation employing examples of carrier data.

FIG. 4 is a diagram illustrating a typical form insurance declarations page employing examples of carrier data.

FIG. 5 is a functional flow diagram illustrating aspects of one implementation of a method of dynamically adjusting insurance premiums during the term of an insurance policy.

### DETAILED DESCRIPTION

Certain aspects and features of the disclosed subject matter may be further understood with reference to the following description and the appended drawing figures. In operation, a system and method employing real time or near real time financial data may have utility in connection with various insurance premium computation strategies and data analytics implementations. Specifically, the present disclosure provides for a system and method that may dynamically adjust insurance premiums based upon data that are periodically acquired from a data processing system associated with the insured.

As set forth in more detail below, the present disclosure addresses design and implementation of an architectural framework that may have utility in connection with underwriting general liability insurance and other policies that may benefit from intra-term premium adjustments that accurately assess the risk of loss for both the insurance carrier and the insured.

As will be appreciated by those skilled in the art, portions of the present system and method may be embodied as a method, a data processing system, a computer program product, or a distributed computing architecture. Accordingly, these portions of the disclosed system and method may be embodied entirely in hardware, entirely in software, or in a combination incorporating both software and hardware (or firmware) aspects. Furthermore, portions or aspects of the disclosed subject matter may be implemented as a computer program product on a computer usable storage medium having computer readable program code or instruction sets and data encoded on the medium. Any suitable computer readable medium may be utilized including, but not limited to, static and dynamic storage devices, hard disks, optical storage devices, and magnetic storage devices. Those arrangements implemented entirely in software may be operative in conjunction with a computer or other data processing apparatus or system employing or comprising, for example, a microprocessor, a microcontroller, a field programmable gate array (FPGA), an application-specific integrated circuit (ASIC), or some other electronic hardware component, that is suitably configured to facilitate the functionality set forth below.

It will be understood that individual blocks depicted in the drawing figures, as well as certain combinations of blocks depicted in the drawing figures, may be implemented by computer program instructions, hardware devices, or a combination of both. These computer program instructions may be provided to a processor of a general purpose computer, special purpose computer, or other programmable data processing apparatus to produce or otherwise to enable a particular machine, such that the instructions, which execute via the processor of the computer or other programmable data processing apparatus, implement the functions specified in the block or blocks, either individually or in combination.

Aspects of the disclosed subject matter may be implemented on or in connection with one or more computing devices, including one or more servers, one or more remote terminals (including computer terminals, POS appliances, or other data processing systems), or any of myriad computing devices currently known in the art, including without limitation, personal computers, laptops, notebook or tablet computers, touch pads, multi-touch devices, smart phones, personal digital assistants, other multi-function devices, stand-alone kiosks, etc.

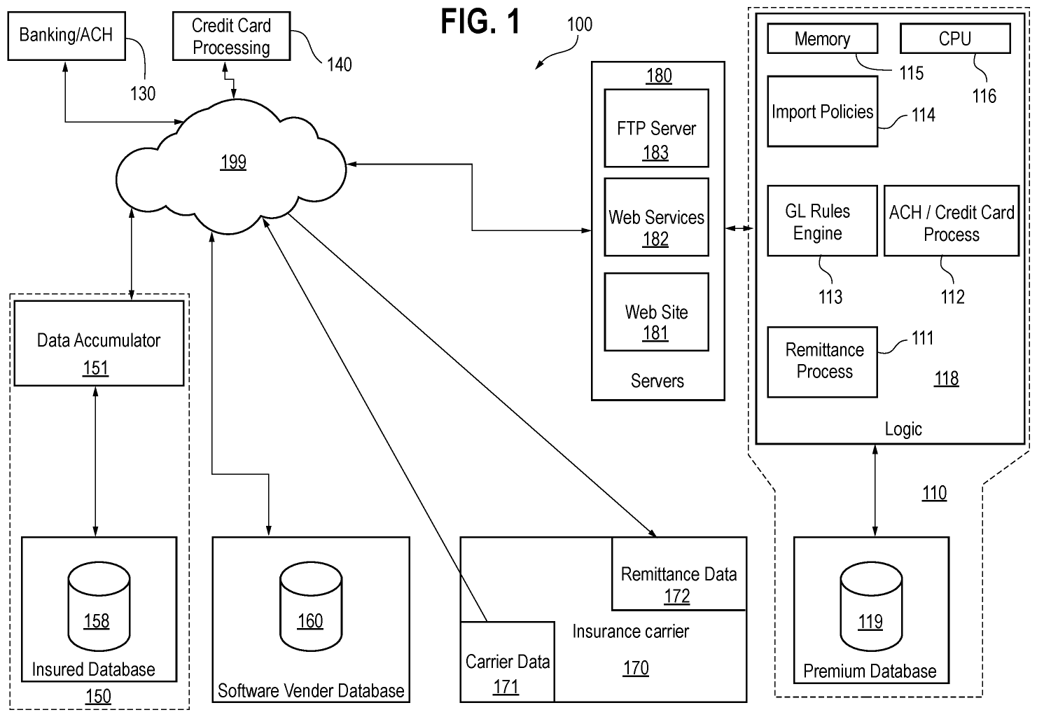

Turning now to the drawing figures, FIG. 1 is a functional block diagram illustrating components of one implementation of a data processing and analytics system for use in connection with an insurance premium adjustment method.

As illustrated, a distributed data processing and analytics system 100 may generally comprise an insured subsystem 150, a carrier subsystem 170, and a premium computation subsystem 110. In operation, subsystems 150, 170, and 110 (and the other components of system 100 discussed below) may be communicatively coupled, directly or indirectly, via a network 199, enabling bi-directional data communications between any or all of the various elements of system 100 as is generally known in the telecommunications arts. In that regard, network 199 may be embodied in or comprise, in whole or in part, a wide area network (WAN) such as the Internet, for instance, a virtual private network (VPN), a local area network (LAN) or intranet infrastructure, or some other hardware and software architecture that is suitable for enabling bi-directional (typically, packet-switched) data communications as set forth below. Conventionally, network 199 may be embodied in or operative in accordance with asynchronous transfer mode (ATM) hardware and protocols, but the disclosed subject matter is not intended to be so limited; any of various and common bi-directional data communications technologies and techniques may be sufficient for facilitating the described functionality, and may be either selected as a design choice or dictated by requirements that are necessary or desirable for interoperability of components of system 100.

Similarly, the arrows interconnecting the functional blocks in FIG. 1 are intended to denote data communications such as are generally known in the art or that are developed and operative in accordance with known principles. Such communications may be wired (e.g., via Ethernet, fiber optic cabling, T1, T2, or T3 lines, and the like), or wireless (e.g., via satellite, cellular, near field communication (NFC) connections, and the like), and may be different for the different connections illustrated in FIG. 1. For instance, some communications may be encrypted (particularly those that are to or from banking/ACH subsystem 130, for example) while others may not be, and some communications may be wireless (particularly those that are local within insured subsystem 150, for example) while others may be wired. Network access cards, cable jacks, antennae, and other supporting network interface and communications hardware have been omitted from FIG. 1 for clarity, but those of skill in the art will appreciate that the disclosed subject matter is not intended to be limited by any particular hardware or telecommunications protocols implemented by the components of system 100 illustrated in FIG. 1, either independently or in combination.

It is noted that the infrastructure of system 100 illustrated in FIG. 1 may comprise or have access to various computers, servers, databases, and other processing or data repository resources to enable, supplement, or otherwise to facilitate some or all of the disclosed functionality of system 100. Specifically, a banking/ACH (i.e., automated clearing house) resource 130, a credit card processing resource 140, and a software database 160 are illustrated by way of example only, and not by way of limitation. Resources 130, 140, and 160 may generally be embodied in, comprise, or have access to one or more microprocessors, microcontrollers, FPGAs, ASICs, or some other electronic hardware or data processing component and attendant memory structures that are suitably configured and operative to execute functionality that is generally known and accepted as industry standard in the electronic commerce and financial transaction arts.

By way of example, banking/ACH resource 130 may generally be owned, operated, or controlled by a financial institution, and credit card processing resource 140 may be owned, operated, or controlled by a similar (or the same) financial institution, or by a third party clearing house or merchant bank, for instance. In that regard, resources 130 and 140 may be integrated in some instances, depending upon the nature of the business of the operator, for example, as a function of governmental or industry regulations applicable to financial institutions, operational characteristics of deployed hardware and software, or a combination of these and various other factors. In operation, these resources 130 and 140 may be configured and operative, either independently or in combination, to process payments or other financial transactions between two parties as is generally known.

Similarly, software database 160 may provide access to software as a service (SaaS) functionality to an insured, an insurance carrier, operators of resources 130, 140, or a combination of these or other entities. Additionally or alternatively, software database 160 may enable downloads of, or otherwise provide access to, software applications that are relevant to finance or other operational aspects of a business. Some software that may be made available (e.g., to resources 130, 140, to insured subsystem 150 or carrier subsystem 170, or to a combination of these) via software database 160 may include applications directed to monitoring, maintenance, control, or management of accounting (e.g., accounts deliverable versus accounts receivable), payroll, sales receipts or revenue, royalty tracking, or a combination of these and other financial metrics or data that are useful for analytics operations. In some implementations, software database 160, or a portion thereof, may be incorporated into or integrated with resources 130 or 140, or may operate in cooperation with server resources 180. Software database 160 may be implemented as a relational or structured query language (SQL) database, for instance, or as another type of content-addressable memory store, without limitation.

Server resources 180, also depicted in FIG. 1, may generally comprise a file transfer protocol (FTP) server 183, a web services server 182, and a web site server 181. These resources 180 may provide network services and interoperability functionality as is generally known in the art. For example, FTP server 183 may be implemented in hardware, software, or a combination of both, and may be configured and operative to facilitate transfer of files or digital data blocks from one computer to another (for example, using “put” and “get” commands) in accordance with FTP standards. Web services server 182 may be implemented as a hardware appliance or other computer apparatus running an application that serves up uniform resource locators (URLs) to remote computers in a format (typically eXtensible markup language (XML), simple object access protocol (SOAP), or the like) that is intended to be parsed by a generic computer program. Similarly, web site server 181 may be implemented as a hardware appliance or other computer apparatus that is configured and operative to serve up URLs or other data stored as websites, for example, in hypertext markup language (HTML) or some similar protocol to be interpreted by a conventional Internet or other browser software application.

In some typical implementations, server resources 180 may be incorporated into the hardware fabric of network 199, and may therefore serve as integrated components of network 199 architecture. Server resources 180 are depicted as external to network 199 in FIG. 1 by way of example only, and not by way of limitation.

It is noted that hardware and functional blocks (e.g., such as ASICS, microprocessors, networking interfaces, memory stores and controllers, power supplies, and computational and other resources) are omitted from the depictions of resources 130, 140, 180 and database 160 in FIG. 1 for clarity. Those of skill in the art will appreciate that the present disclosure is not intended to be limited by the architectures or functional characteristics of these components, and that various implementations may be equally suitable for the overall operation of system 100 as described and claimed.

During use, insured subsystem 150 may acquire or generate sales or other financial data in real time or near real time as business is conducted. In that regard, insured subsystem 150 may generally comprise or have access to a data processing system or other computer appliance that is operated or maintained by an insured; a data accumulator 151 may be embodied in or comprise hardware, firmware, software, or a combination thereof, to acquire sales or other financial data (individually or collectively, “insured data”) related to business operations of the insured. Data accumulator 151 may be a POS terminal or appliance, for instance, through which credit card transactions may be processed; in such an implementation, in addition to pre-processing, encryption, or other data manipulations that are required for transmission of transaction data (e.g., to resources 130, 140, or both) necessary or desirable to consummate a financial transaction via a POS, data accumulator 151 may also be configured and operative to transfer or transmit such data (either before, concomitantly with, or after such pre-processing or manipulation) to an insured database 158, to other components of a data processing system associated with or accessible by insured subsystem 150, to premium computation subsystem 110, or to a combination of these components.

Those of skill in the art will appreciate that data accumulator 151 may be embodied in or comprise any of various types of data sources that acquire, receive, manipulate, process, or otherwise act on data that may be relevant to an insured's business operations. For example, data accumulator 151 may be a sales database, a payroll software application, an accounting software application or suite of applications, a royalty or commissions tracker, or the like. Particularly in the case of underwriting policies for a retail establishment, an insurance carrier is interested in using sales receipts or accounts receivable data to drive its policy estimates, and so any software package or hardware appliance that is capable of acquiring (directly or indirectly) such insured data and communicating same to other components of insured subsystem 150 or to premium computation subsystem 110 may have utility as an implementation of data accumulator 151. While a POS terminal is a good example of one embodiment of data accumulator 151 that may acquire, process, and transmit insured data related to real time or near real time financial information associated with the insured's business operations, other embodiments (such as those set forth above) may be suitable, and may augment or serve as a substitute for a POS appliance as a function of the nature of the insured's business, operational characteristics of the insured's enterprise information technology (IT) infrastructure, software applications deployed and the type of insured data being acquired or tracked, or a combination of these and other factors.

In accordance with some implementations, insured data may be stored in insured database 158, for example, or in another data storage facility that may be maintained at the insured's premises or remotely, in some instances. Additionally or alternatively, insured database 158 may store or maintain other data relevant to the insured's business, e.g., that were not acquired by data accumulator 151, but that may nevertheless have utility in the context of determining a premium rate for the insured by premium computation subsystem 110. In the context of the present disclosure, the term “insured data” is intended to encompass both data acquired by data accumulator 151 as well as other data that may be resident in or accessible via insured database 158. Specifically, it will be understood that “insured data” may refer to raw data (i.e., unmodified or unprocessed data as they are acquired and that represent an amount of currency changing hands, for example, at the location serviced by data accumulator 151) or to data and other information relating to or derived from such raw data (e.g., processed data including information that represents more than simply an aggregate or a measure of metrics acquired by data accumulator 151). For example, in some instances, only an aggregate or per-transaction value may be transmitted from insured subsystem 150, while in other instances, detailed, time-dependent values may be transmitted; the specific type and amount of insured data collected and processed at, and transmitted from, insured subsystem 150 may be application-specific and may vary in accordance with processing or computational capabilities of hardware components deployed in, as well as software functionalities implemented at or in cooperation with, data accumulator 151 or other components of insured subsystem 150. These factors may be affected by technological or economic considerations, for example, or may be dictated or influenced by applicable governing bodies or governmental regulations.

As with other components of system 100 illustrated in FIG. 1, functional blocks (such as network interfaces, processing elements, memory controllers, and the like) have been omitted from insured subsystem 150 for clarity. These components are conventional, or may be designed and operative in accordance with known principles, and so are not described in detail here. In the context of overall operation of insured subsystem 150, however, it will be appreciated that a data processing system that is operated or maintained by an insured, in cooperation with suitable networking hardware and software, may manipulate or otherwise process insured data that are collected or acquired in real time or near real time, and may transmit either raw data or processed data to resources 130 and 140, to premium computation subsystem 110, or both. Further, it is noted that, though depicted in FIG. 1 as a single, unified entity, insured subsystem 150 may represent any number of physical buildings, computer server facilities, and other physical and logical resources owned, operated, or otherwise under the control of the relevant insured.

Specifically, insured subsystem 150 may process, encrypt, or otherwise modify the nature of insured data such that it may then be transmitted to other components of system 100 (such as premium computation subsystem 110, carrier subsystem 170, or resources 130 and 140). For example, it may be desirable in some circumstance to encrypt insured data, or to aggregate or average values of portions of insured data prior to transmission from insured subsystem 150. Various techniques are known or may be developed to manipulate insured data prior to transmission, and the present disclosure is not intended to be limited by the operation of subsystem 150 or by any technical procedures executed or functionality employed there.

Carrier subsystem 170 may generally be owned, leased, operated, or otherwise maintained by an insurance carrier that has a relationship with the insured with which insured subsystem 150 is associated. In one implementation, carrier subsystem 170 may generally comprise or have access to a data processing system, server or system of distributed servers, or other computer appliance or appliances (not illustrated in FIG. 1) that is operated or maintained by the carrier. Data related to a particular insured such as contact information, risk ratings, business sector (as such may affect coverage offerings, for example), and the like, as well as to the insured's underwritten insurance policy such as policy term, coverage limits, exclusions, premium payments, payment periodicity, and the like (individually or collectively, “carrier data”) may be stored or maintained in a database or other data structure (carrier database 171). Carrier database 171 may generally be maintained at the carrier's premises, for instance, or remotely, depending upon the carrier's IT infrastructure or other factors. Similarly, data related to premium payments made by an insured (i.e., “remittance data”) may also be stored (e.g., locally or remotely) in a database or similar data store, such as payment database 172, such that the carrier may monitor and record an insured's account as it relates to any and all active insurance policies or coverages.

Carrier subsystem 170 may be embodied in or comprise hardware, firmware, software, or a combination thereof such as the components described above, to enable or otherwise to support business operations of the carrier. In that regard, carrier subsystem 170 may generally comprise processing and billing systems that handle various monitoring, customer service, troubleshooting, maintenance, load balancing, accounting, billing, and other types of activities that are necessary or desirable to service an insurance carrier's customer base. In some instances where such activities are computationally expensive or require a great deal of processor power or communication bandwidth, some implementations of carrier subsystem 170 may be distributed across many processing and memory storage resources, and even distributed across buildings as is generally known in the art. Insurance carriers typically employ websites, SaaS portals, or other software applications and business related methodologies at carrier subsystem 170 (or possibly using resources 180), and so these conventional aspects will not be described in further detail. As noted above, carrier subsystem 170 may represent any number of physical buildings, computer server facilities, and other physical and logical resources owned, operated, or otherwise under the control of a particular carrier as is generally known in distributed enterprise computing systems.

In some arrangements, it may be desirable to omit the connection between carrier subsystem 170 and premium computation subsystem 110 via network 199, i.e., by integrating functionality of premium computation subsystem 110 within carrier subsystem 170. This option may have particular utility for large insurance carriers with sufficient IT resources to implement the functionality of premium computation subsystem 110 independently, i.e., without using a third party provider. Such an architecture may also minimize the necessity for encryption or exposure to third party interlopers that may intercept insured data or carrier data during communications across network 199.

As indicated in FIG. 1, one implementation of premium computation subsystem 110 may generally comprise a premium database 119 and a logic engine 118. Premium database 119 may be embodied in or comprise a relational or SQL database, or any other type of content-addressable memory store as is generally known in the art. In use, premium database 119 may store and maintain data related to premium payments (e.g., amounts, periodicity, late payment terms or interest rates, overdue premium payments, and the like) for each insured and each policy that is monitored by subsystem 110 (i.e., for multiple insureds and multiple carrier subsystems 170). Similarly, averages, means, and cross-correlated data records may be maintained at premium database 119 to support machine learning (ML) or artificial intelligence (Al) algorithm processing at premium computation subsystem 110, if desired.

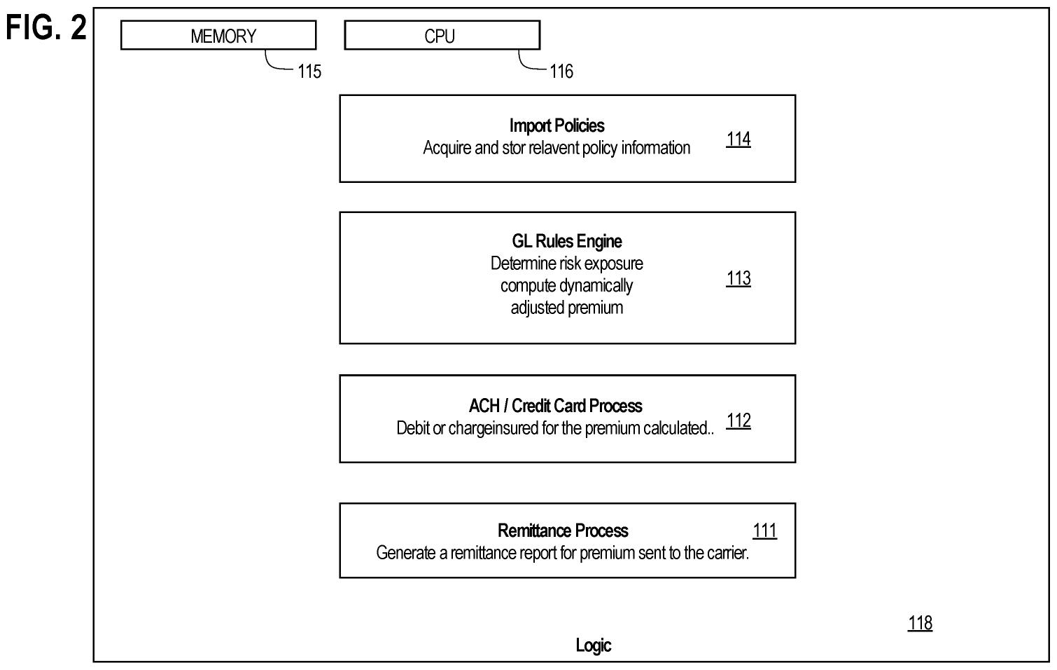

With reference now to FIGS. 1 and 2, it is noted that FIG. 2 is a functional block diagram illustrating components of a logic engine supporting functionality of an insurance premium adjustment method. In the illustrated implementation, logic engine 118 may generally comprise a remittance process component 111, an ACH/credit card process component 112, a general liability (GL) or other rules engine 113, an import policies component 114, a memory 115, and a central processing unit (CPU) component 116.

CPU component 116 may generally comprise one or more microprocessors (which may be multi-core, multi-threaded, both, or neither) or microcontrollers, FPGAs, ASICs, programmable logic controllers (PLCs), or other analogous or similar digital processing apparatus sufficient to enable or to support the functionality described below. Memory 115 may be embodied in or comprise, by way of example, volatile memory such as random access memory (RAM) in any of its various forms, for instance, static RAM (SRAM), dynamic RAM (DRAM), double-data rate (DDR) RAM, and the like. Additionally or alternatively, memory 115 may include or have access to other forms of memory technology such as solid state devices (SSDs, e.g., Flash™ memory) and other data storage hardware media having no moving parts or motors and having relatively short access/read/write times as compared to traditional spinning media. Memory 115 may also be embodied in or have access to conventional spinning media, such as hard or floppy disks, digital versatile disks (DVDs), and the like. Attendant bus structures and memory controller elements are omitted from FIGS. 1 and 2 for clarity, but are generally well-known in the art. In operation, CPU component 116 and memory 115 may cooperate to provide necessary or desirable data processing operations to support the functionality of logic engine 118.

In that regard, operational characteristics of logic engine 118 are generally represented in FIGS. 1 and 2 by the functional blocks depicting components 111 through 114.

Import policies component 114 may generally receive carrier data and insured data (for example, from carrier subsystem 170, insured subsystem 150, or both); accordingly, information related to or associated with an insured and the insured's relevant policy coverages and premium payment obligations and history may be acquired by logic engine 118 and stored (e.g., in memory 115 or a database or other suitable memory store (not shown in FIGS. 1 and 2)) for further processing.

In some implementations, import policies component 114 may be considered to be operating in a “passive” capacity. For example, where a new insured is engaged by a carrier, or where an existing ensured acquires a new policy or class of coverage, software scripts or other instruction sets executing at or in cooperation with carrier subsystem 170 may (unbidden or otherwise not in response to a particular request) transmit carrier data to component 114, which may then create one or more new records for the newly-recognized insured or policy. Additionally or alternatively, import policies component 114 may be operate in an “active” capacity in which software scripts or other instructions sets executing in component 114 cause logic engine 118 to poll (or to “ping”) carrier subsystem 170, insured subsystem 150, or both for information related to any new insured or any new policy; the term “new” in this context generally is meant to refer to engagement with an insured or execution of a policy that is more recent than the last time records were updated at logic engine 118. Such polling may take place periodically (such as once per week, once per month, or once per calendar quarter, for example), or it may be triggered, controlled, or otherwise influenced by the occurrence of a particular event (e.g., expiration of a policy term, receipt of an unallocated payment that does not match an existing insured or an existing policy, or the like).

It will be appreciated that any of various methodologies may be used to acquire and store relevant policy information as set forth above with reference to component 114. The disclosed subject matter is not intended to be limited to any particular communications protocols, records parsing methodologies, polling frequencies or strategies, or data recordation techniques implemented at import policies component 114, as these and other operational characteristics may be selected as a matter of design choice or as a function of the computational capabilities or data storage paradigms of logic engine 118.

Rules engine 113 may be configured and operative to determine a carrier's exposure to risk and, ultimately, to compute a dynamically adjusted premium payment based upon the latest insured data and carrier data that are available to logic engine 118. In operation, rules engine 113 may apply a set of rules or execute one or more algorithms using variables acquired (directly or indirectly) from insured data, carrier data, or both, for this purpose. In some implementations, rules engine 113 may employ ML/AI algorithms that leverage previous analyses to assist with risk management and premium computations; specifically, operations at rules engine 113 may employ historical data or previous results (in addition to current insured data and carrier data) to execute computations of premium payments.

By way of example, if historical data indicate that values for a particular insured's sales (volume, revenue, or both) estimates have been consistently low, then rules engine 113 may take recent and repeated underestimates (as well as the magnitude of the underestimates) into account during current computations related to determining a dynamically adjusted premium rate. Similarly, if overall market trends in a particular insured's industry indicate that recent data may be unreliable or inaccurate (e.g., overly optimistic or pessimistic, as the case may be) for an entire industry or business sector, then rules engine 113 may apply ML/AI techniques to account for market inertia and to weight variables associated with the particular insured's short term results accordingly. In some instances, historical or market trend data employed by rules engine 113 may be acquired as part of carrier data; additionally or alternatively, some data employed by rules engine 113 may be acquired from third party sources, such as via resources 130, 140, or 180.

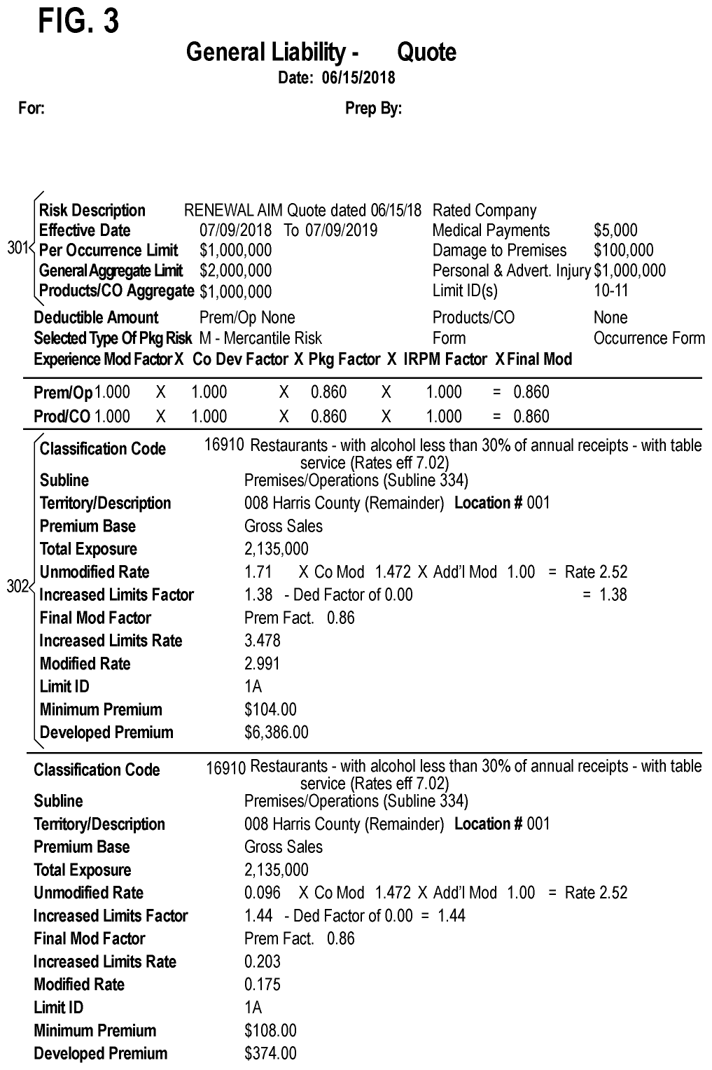

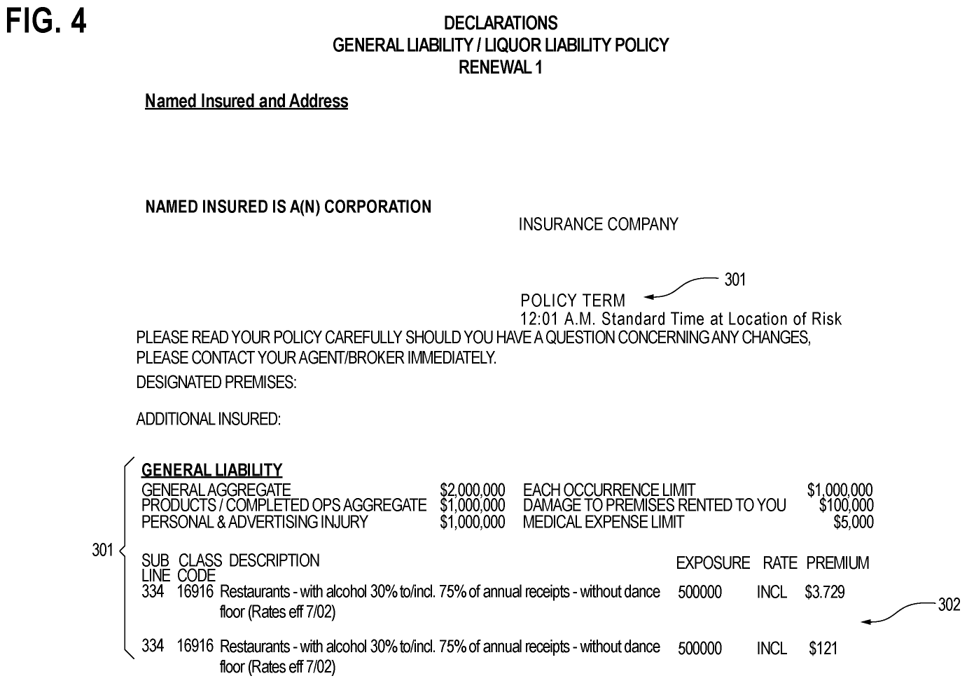

Those of skill in the art will appreciate that different insurance carriers may have different exposure thresholds and different heuristics to assess insurability or to compute premiums, and that even within a single carrier, different rules may apply to different insureds, for instance, as a function of the business relationship with the carrier, whether the insured has subscribed to bundled services, overall risk profile and projected revenue for the carrier, the nature of the insured's business, and the like. Historic course of business or the relationship established over time with a particular insured may be taken into consideration, for instance; a long-standing relationship may lead to a “most favored” or preferred status for an insured with respect to a particular carrier's risk profile, whereas a new or recently engaged insured without an established payment history may not be eligible for preferred or discounted rates. These and a variety of other factors may be taken into account at rules engine 113, and may be typically encoded in carrier data supporting data processing operations at premium computation subsystem 110; several such variables that may typically be associated with carrier data are illustrated in FIGS. 3 and 4, by way of example.

In some implementations, rules engine 113 may employ hardware (such as CPU component 116 and memory 115) or software resources resident at or accessible by logic engine 118; alternatively, some or all of the functionality of rules engine 113 may be implemented within the functional block 113 itself, such that rules engine 113 may embody or comprise sufficient hardware, firmware, and software resources, modules, or other components to compute premium payments as set forth herein. Whether operating independently or in cooperation with other components, rules engine 113 may employ insured data, carrier data, and possibly market trends, previous calculation results, and other information to determine real time or near real time adjustments to premium payments that may be necessary or desirable for a particular insured and a particular policy and consistent with the carrier's desired risk profile; in this context, the adjustments to premium payments may be made as new or updated information becomes available, i.e., during the term of the applicable insurance policy.

It is noted that rules engine 113 is described with reference to GL insurance policies by way of example only, and not be way of limitation. Rules engine 113 may readily be adapted to apply any desired set of rules or instruction sets, some of which may be unrelated to GL insurance, that are designed or optimized to take into consideration variables that may change during the course of a particular insurance policy term.

Irrespective of the particular algorithms or rules applied, it is noted that rules engine 113 may be configured and operative to use the most recent information available (i.e., insured data and carrier data) to compute, or to facilitate computation of, a dynamically adjusted premium payment that is suitable for a particular insured and for that particular insured's particular policy, taking into consideration coverage limits, risk exposure for the carrier, and various other parameters. For example, and in the context of GL insurance for a retail establishment, real time or near real time insured data (e.g., acquired by data accumulator 151 and received from insured subsystem 150) and carrier data associated with the insured's policy may be used compute a premium payment for the month following acquisition of the insured data; that premium payment may be higher or lower than the premium that was due in the month during which the data were acquired. In a departure from conventional insurance underwriting methodologies, rules engine 113 may enable premium computation subsystem 110 to intercede in the relationship between insured and carrier, both by determining a proper premium payment as circumstances of the insured's business change, as well as by billing and collecting same on behalf of the carrier.

ACH/credit card process component 112 may be configured and operative to charge a payment, or to credit any previous overpayment, as the case may be, to an account associated with an insured. In that regard, component 112 may be operative (either independently or in cooperation with CPU component 116 and memory 115) to communicate with one or both of resources 140, 130, such that initiation and consummation of a financial transaction may be effectuated. Typically, in the event of a premium payment, such a transaction may involve debiting an account associated with the insured and subsequently or substantially simultaneously crediting an account associated with the carrier; in the alternative, i.e., in the event of a refund, such a transaction may involve debiting an account associated with the carrier and crediting an account associated with the insured. In either event, logic engine 118, under control of or influenced by component 112, may engage in bi-directional data communications with resources 140, 130 as appropriate to complete the transaction as is generally known in the electronic commerce arts. This may involve or require handshaking, authentication, verification, and other technologies generally known in the art or developed and operative in accordance with known principles. In some embodiments, interaction with carrier subsystem 170 may not be necessary, and so may be avoided altogether by component 112 that is responsible for effectuating funds transfers and completing the financial transaction. It will be appreciated that the disclosed subject matter is not intended to be limited by any particular methodologies or techniques used to complete these financial transactions, though it is noted that current systems and financial institution infrastructures do not contemplate an intermediary (such as premium computation subsystem 110) participating in such transactions at all, particularly in the context of variable insurance premium payments.

Remittance process component 111 may be responsible for communicating updated records, files, or other financial data relevant to a recently effectuated financial transaction to carrier subsystem 170 as indicated in FIG. 2. Specifically, remittance process component 111 may embody or comprise sufficient hardware, firmware, and software resources, modules, or other components to generate a remittance report (either independently or in cooperation with CPU component 116 and memory 115) and to transmit same to carrier subsystem 170. As noted above, in some instances, logic engine 118 may be incorporated into or integrated with carrier subsystem 170, in which case, component 111 may simply be configured to generate such a report and to provide it locally to an appropriate additional component or memory store internal to carrier subsystem 170. The nature and format of the report generated at component 111 may be specified by the carrier, for example, or it may be predetermined or otherwise influenced by applicable regulations or financial industry standards. It is noted that the same or similar information as that communicated to carrier subsystem 170 may also be transmitted to insured subsystem 150, so that both parties to the transaction have accurate records of the transaction.

FIG. 3 is a diagram illustrating a typical form insurance coverage quotation employing examples of carrier data, and FIG. 4 is a diagram illustrating a typical form insurance declarations page employing examples of carrier data. In the illustrated example, elements or variables that may be representative of or included in carrier data are depicted in connection with an hypothetical insurance policy for an insured in a retail business involving sales of alcohol, though it will be appreciated that many of the same or similar variables may be elements of carrier data irrespective of an insured's business. Term and coverage limits data 301, specific risk factor data 302, and other information taken into consideration by a carrier are illustrated by way of example only, and not by way of limitation. These and other types of variables may be included with carrier data to be employed by premium computation subsystem 150 substantially as set forth herein.

It is noted that the variable values, ranges, and any weights that are to be attributed to these, as well as the type, nature, and encoding paradigms that may influence operation of logic engine 118 or other components of system 100 may be carrier-specific and policy-specific, and that the manner in which logic engine 118 parses carrier data to extract coverage limits data 301, specific risk factor data 302, and other relevant information may vary accordingly. In some instances, instructions or directions for unpacking carrier data may be embedded or encoded into the carrier data themselves, such that import policies component 114 may parse the information provided by carrier subsystem 170 in such a matter that coverage limits data 301, specific risk factor data 302, and other relevant information are identifiable and useable by rules engine 113. Alternatively, rules engine 113 or other components of logic engine 118 may be pre-apprised or pre-coded with instructions on formatting and other structural aspects of forms to facilitate extraction of relevant carrier data. In other embodiments, carrier data may be provided to premium computation subsystem without any formatting or structural framework at all, in which case it may be necessary or desirable to incorporation parsing or extraction instructions within the carrier data.

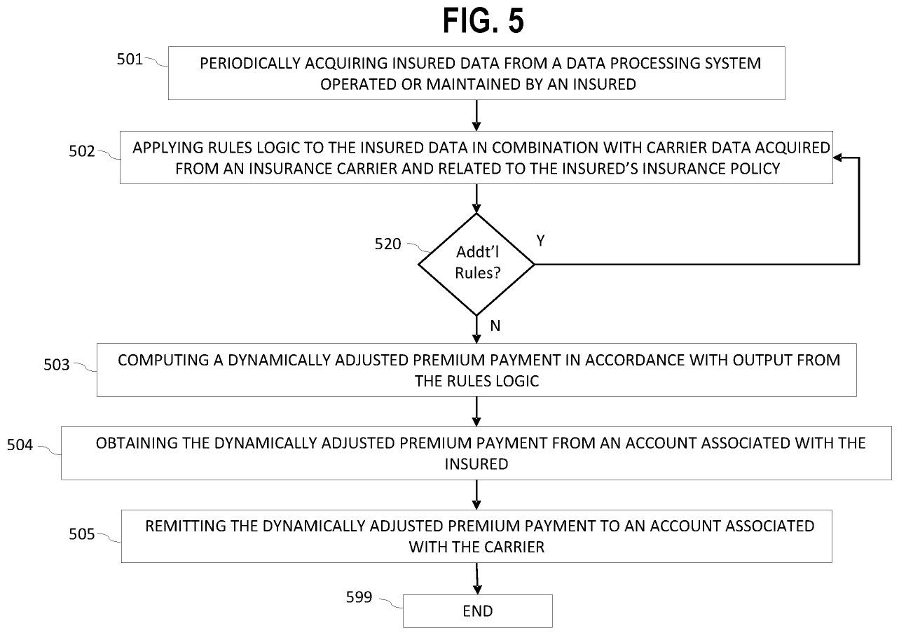

FIG. 5 is a functional flow diagram illustrating aspects of one implementation of a method of dynamically adjusting insurance premiums during the term of an insurance policy.

As indicated in FIG. 5, a method of dynamically adjusting insurance premiums may begin (at block 501) with periodically acquiring insured data from a data processing system operated or maintained by an insured (such as from insured subsystem 150 described above with reference to FIG. 1). As noted above, this operation may be executed by suitable hardware or software, such as component 114 at logic engine 118, for example, responsible for acquiring and managing current and historical insured data. The periodicity of the acquisition process may vary in accordance with carrier (or insured) preferences, for instance; additionally or alternatively, acquisition may be based upon predetermined or unpredictable events. For instance, the acquiring operation at block 501 may occur at regular intervals (such as daily, weekly, quarterly, etc.), upon policy expiration, or when an unexpected event occurs.

The method may continue by applying rules logic to the insured data in combination with carrier data acquired from an insurance carrier and related to the insured's insurance policy (block 502). In this context, the term “carrier data” generally includes those data and other information described above with reference to FIGS. 1 through 4; rules logic, as well as supporting or attendant hardware and software, may be implemented by rules engine 113 as set forth above. The operation depicted at block 502 may employ ML or Al algorithms or other adaptive or generative heuristics designed and operative to use previous results to improve the accuracy of current calculations. Where additional rules are relevant or have yet to have been applied (decision block 520), the method may loop back to block 502; this iterative process may continue until all rules have been applied to the current insured data set in conjunction with variables associated with carrier data.

Where all relevant rules have been applied to the most current data set (also at decision block 520), the method may continue by computing a dynamically adjusted premium payment in accordance with output from the rules logic (block 503). As noted above, this departure from current insurance underwriting methodologies allows targeted or customized premium values to be applied for a particular insured's policy during the term of the policy, such that the premium payments are allowed to vary as the insured's fiscal circumstances or other relevant financial data vary over time. In that regard, the term “dynamically adjusted” in this context refers to the fact that a premium payment amount may be changed as new insured data are periodically acquired, i.e., during the policy term and irrespective of any fixed payment amounts described or prescribed in the policy agreement.

Once the new (dynamically adjusted) premium payment amount has been determined, the method may continue by obtaining the dynamically adjusted premium payment from an account associated with the insured (block 504) and remitting same to an account associated with the carrier (505). As noted above, these operations may be initiated or facilitated by components 112 and 111, respectively, at logic engine 118, and may require or benefit from functionality at resources 130, 140.

Upon consummation of the financial transaction, the method may conclude as indicated at block 599.

The arrangement of the blocks and the order of operations depicted in FIG. 5 are not intended to exclude other alternatives or options. For example, it will be appreciated that in accordance with one embodiment, the operations depicted at blocks 501 and 502 may be executed substantially simultaneously, or may be integrated into a single operation. As another example, the operation depicted at block 502 may be executed concomitantly with the operations at blocks 520 and 503, or these processes may be integrated into a single operation. These and other such alternatives may readily be effectuated without materially impacting results of the method or the functionality of any particular hardware implementation utilized to execute the method. In addition to the alternatives set forth in detail above, various design choices that may influence the order or arrangement of the operations depicted in FIG. 5 will be readily apparent to those of skill in the art.

Several features and aspects of a system and method have been illustrated and described in detail with reference to particular embodiments by way of example only, and not by way of limitation. Those of skill in the art will appreciate that alternative implementations and various modifications to the disclosed subject matter are within the scope and contemplation of the present disclosure. Therefore, it is intended that the present disclosure be considered as limited only by the scope of the appended claims.

What is claimed is:

1. An insurance premium computation method comprising:
periodically acquiring insured data from a data processing system operated or maintained by an insured, the insured data related to a business operated by the insured;
applying rules logic to the insured data in combination with carrier data acquired from an insurance carrier and related to an insurance policy associated with the insured;
computing a dynamically adjusted premium in accordance with output from the rules logic;
obtaining a payment in an amount of the dynamically adjusted premium from a first account associated with the insured; and
remitting the payment to a second account associated with the carrier.

2. The method of claim 1 wherein the data processing system is a financial resource system.

3. The method of claim 2 wherein the financial resource system is a point of sale (“POS”) terminal.

4. The method of claim 2 wherein the financial resource system is an accounting software application.

5. The method of claim 1 wherein the computing comprises utilizing a machine learning algorithm.

6. The method of claim 1 wherein the periodically acquiring comprises receiving insured data related to a present financial transaction in near real time.

7. The method of claim 6 wherein the insured data are representative of a monetary value of the present financial transaction.

8. An insurance premium computation system comprising:
a data processing system operated or maintained by an insured and operative to acquire insured data related to a business of the insured;
rules logic to receive the insured data from the data processing system and carrier data from an insurance carrier, the carrier data related to an insurance policy associated with the insured;
a processing component to compute a dynamically adjusted premium for the insurance policy in accordance with output from the rules logic; and
a financial transaction engine, the financial transaction engine to obtain a payment in an amount of the dynamically adjusted premium from a first account associated with the insured and to remit the payment to a second account associated with the insurance carrier.

9. The system of claim 8 wherein the data processing system is a financial resource system.

10. The system of claim 9 wherein the financial resource system is a point of sale (“POS”) terminal.

11. The system of claim 9 wherein the financial resource system is an accounting software application.

12. The system of claim 8 wherein the processing component utilizes a machine learning algorithm.

13. The system of claim 8 wherein the data processing system acquires insured data related to a present financial transaction in near real time.

14. The system of claim 8 wherein the insured data are representative of a monetary value of the present financial transaction.
